(19) United States
(12) Patent Application Publication
(10) Pub. No.: US 2004/0135761 A1
(43) Pub. Date: Jul. 15, 2004

(54) Bi-directional matrix addressing LCD panel for landscape and portrait display

(76) Inventors: Yu-Min Cheng, San Jose, CA (US); Ming-Wu Cheng, San Jose, CA (US)

Correspondence Address: Yu-Min Cheng, 3519 Speno Drive, San Jose, CA, 95117, US

(21) Appl. No.: 10/743,886

(22) Filed: Dec. 22, 2003

Related U.S. Application Data
(60) Provisional application No. 60/436,269, filed on Dec. 24, 2002.

(51) Int. Cl. G09G 3/36

(52) U.S. Cl. 345/100

(57) ABSTRACT

This invention uses the “row/column buffer switches” to make it possible that LCD display can scan either vertically or horizontally. This invention solved the limitation of the traditional LCD can only scan in one direction (horizontal) issue. That makes LCD will be able to accept either the landscape or the portrait images without a pre-rotate process. With the easy implementation, buffer switches can be applied to both of the two standards, STN (known as passive matrix addressing) and TFT (known as active matrix addressing) LCD devices.

### BACKGROUND

For a standard LCD (STN or TFT), pixels are driven by the column and row drivers. The control block diagram of a STN LCD is illustrated in FIG. 1. It is because the scan time is limited a crucial factor to support the sufficient refresh rate of a LCD panel. Usually the smaller side of the LCD panel is selected as the row (scan) and the wider side of the LCD panel is selected as the column of a non-square display (Ex, VGA, SVGA, and XGA . . . ), usually. Which is known as the landscape mode.

As the growing need of the portrait mode display applications (Ex, the Microsoft Tablet PC). The portrait mode would be used as frequently as the landscape mode in those kinds of applications. The conventional single-direction (column/row) LCD devices (landscape display devices) are no longer adequate for the portrait mode display. The most current solutions are either using software or hardware (graphic control devices) to pre-rotate the display image before it is send to the LCD device. Those solutions are facing the slow performance issues under the portrait mode, because the hardware memory's paging limitation, that memory can not be accessed vertically as fast as horizontally. And the slow performance of display devices can cause the screen tearing issue when playback video in full screen mode.

### SUMMARY OF INVENTION

This invention allows the LCD to scan either vertically or horizontally. That the LCD will accept either the landscape or the portrait images without a pre-rotate process. And the dynamic column and row selection scheme will solve the slow portrait display issue.

This invention uses the “row/column buffer switches” to make it possible that LCD display can scan either vertically or horizontally. The buffer switches can be applied to both of the two standards, STN (known as passive matrix addressing) and TFT (known as active matrix addressing) LCD devices, with two different schemes to accomplish the addressing issues. These two schemes “The Extra Scan Lines” and “The Extra Column Buffer” Scheme will be described in the following sections.

For a STN (passive matrix addressing) LCD the electrode of the video signal and scan signal can be reversed without cause a significant effect. For a TFT (active matrix addressing) LCD a LC cell is turned on/off through the FET (Field Effect Transistor); the draining current is always flow in one direction when the cell is turned on. Two kinds of current redirection circuit can be applied to address the electrode issue—“Common Source Circuit” and “Common Drain Circuit” methods. And these two methods will also be described in the following descriptions.

### DESCRIPTION OF THE DRAWINGS

FIG. 1. The block diagram of STN row and column control for PHM display.

FIG. 2. The diagram of a simplified Passive Matrix Addressing of TN Display with dual scans scheme.

FIG. 3. The diagram of the extra scan line scheme.

FIG. 4. The diagram of the extra column buffer scheme.

FIG. 5. Simplified Row in the TFT LCD Panel.

FIG. 6. The Common Source Circuit method.

FIG. 7. The Common Drain Circuit method.

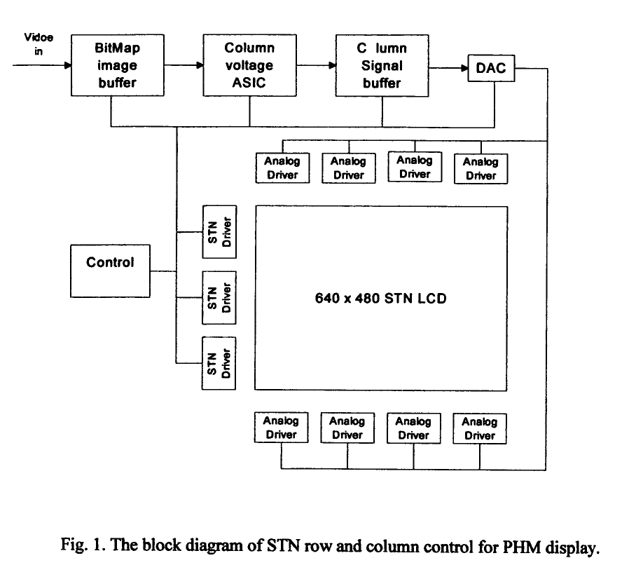

### DECSRIPTION

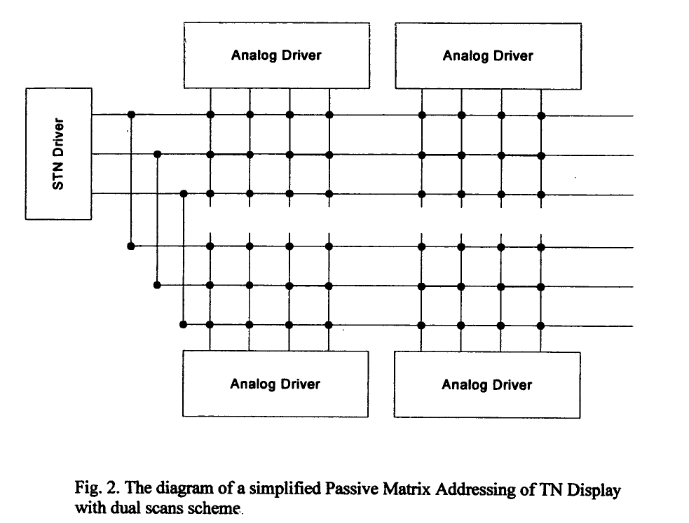

This invention uses the Row/Column Buffer Switches to control the LCD scanning direction (vertically or horizontally). With a non-square panel, scan in different direction will encounter the different scan lines issue. The different scan lines issue can be solved by two different schemes—The Extra Scan Line scheme and the Extra Column Buffer scheme. And these two schemes will be described, based on a simple 4×3 Passive Matrix LCD with row and column electrodes. For those LCDs use the modification of dual scan scheme (please refer to FIG. 2) can be applied similarly.

For the Active Matrix LCD, we shall apply not only the buffer switches but also need to add extra current redirection circuit on each LC cell. The Common Source Circuit and the Common Drain Circuit method will described too.

### The Row/Column Buffer Switch

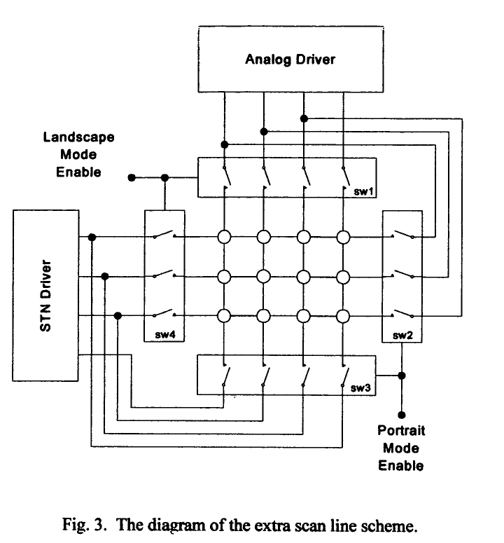

The primary concept of this invention is adding row and column switches around the LCD panel, therefore scanning direction can be controlled by turn on off different row/column switches. Please refer to the FIG. 3. The Row/Column switches are controlled by the Landscape/Portrait Mode Enable Signals. The Landscape/Portrait signals are exclusive to each other.

When the landscape mode is enabled, in FIG. 3, switch 1 and switch 4 are conducted and switch 2 and switch 3 are kept open. Therefore, the LCD panel will act as a traditional LCD panel. When the portrait mode is enabled, in FIG. 3, switch 2 and switch 3 are conducted, and switch 1 and switch 4 are kept open. Therefore, the video signals will be driven through switch 2, while the scan signal will be driven through switch 3. For a passive matrix addressing LC cell, which can be driven by either positive or negative voltage, the direction of current would not be an issue for this implementation. Therefore, we will use the Passive Matrix Addressing Panel to describe how do we solve the different scan lines issue with the Extra Scan Line and Extra Column Buffer Schemes.

### The Extra Scan Line Scheme

In this scheme, four sets of on/off switched are added around the LC panel. Please refer to FIG. 3. And the switches are controlled by the Landscape/Portrait Mode Enable Signals. When the portrait mode is enabled, we will encounter a problem. The scan line will be changed to four instead of three while in the landscape mode. In order to keep the same refresh rate of the screen with extra scan lines, the scan time on each line shall be reduced. For example, in FIG. 3 the portrait scan time t′ would be reduced to ¾ of the landscape mode's scan time t (t′=¾ t). However, this issue can be solved by raising the scanning voltage to compensate the deem issue caused by the reduced time.

### The Extra Column Buffer Scheme

From the Extra scan Line scheme, we learned the disadvantage that we have to reduce scan time and raise scan voltage to make the LCD work properly. We have some improvement in the Extra Column Buffer Scheme.

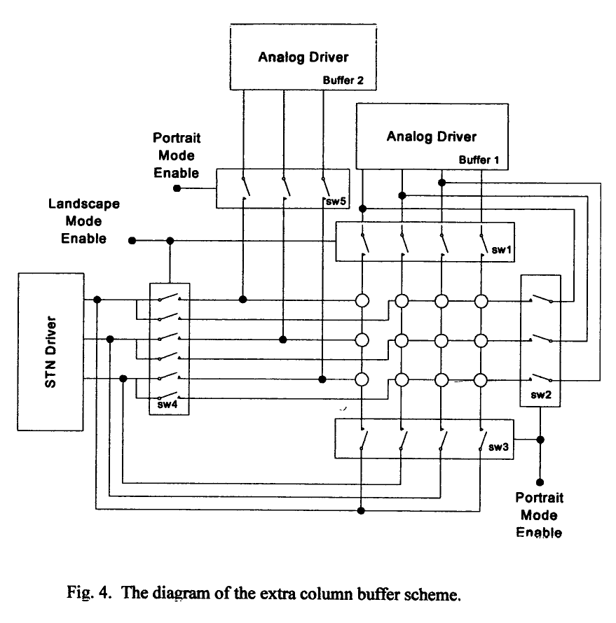

In this scheme, we use the dual-scan technique to cover the extra lines those need to be scanned. The extra line will be scanned the first line. Please refer to FIG. 4. In this scheme we add an extra video signal driver (Buffer 2) to cover the last line illustrated in the FIG. 4. The display control devices should load the video data into Buffer 1 and Buffer 2 within the same scan period. Therefore, we can keep the same scan time and same scanning voltage.

### For the Active Matrix Addressing with TFT

For a Passive Matrix Addressing LCD, the electrode of the video signal and scan line signal can be reversed without cause a significant effect. Therefore, we did not have to concern the current direction went through the LC cell.

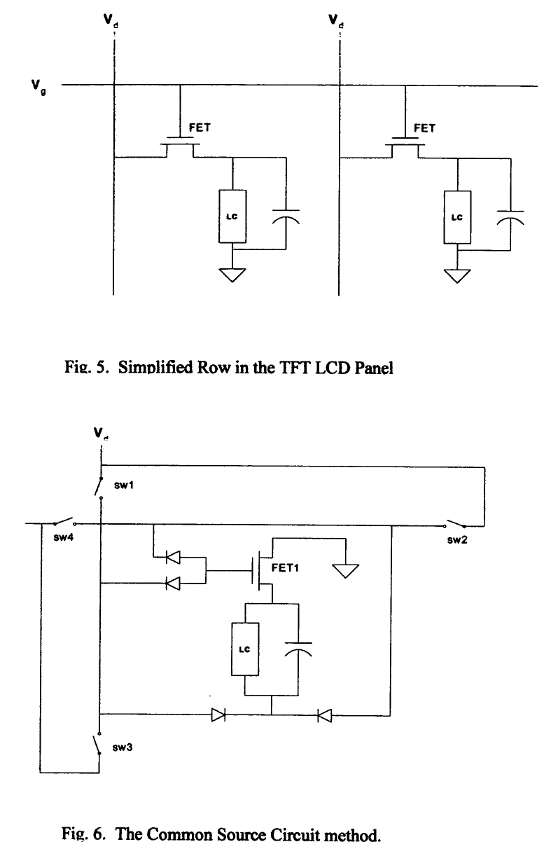

For an Active Matrix Addressing LCD, usually the LC cell is turned on/off through a FET (Field Effect Transistor). The draining current is always flow in one direction when it is turned on. Now the direction of current becomes an issue. FIG. 5 illustrates a simplified one row circuit that how pixels are addressed in the TFT panel. It is because the video voltage V_{d} of a Field Effect Transistor can only work in one current direction; we cannot ignore the current through the TFT LCD the same way in the STN LCD circuit. When portrait mode is selected. Each pixel cell will use an independent circuit to redirect the gate voltage V_{g} and the video voltage V_{d} to drive the Gate and Drain ports of the FET in FIG. 5.

In order to achieve the portrait display capability, we can apply either the “Extra Scan Line” or the “Extra Column Buffer” scheme, then add one extra circuit to swap the video and gate current of the FET on each LC cell. The redirecting video and gate current circuit can also be implemented in two ways—The “Common Source Circuit” and the “Common Drain Circuit” scheme.

### The Common Source Circuit

In this circuit, a normal-on N channel FET is used as the LC switch and four diodes are used to swap the video and gate current. Please refer to FIG. 6. The normal-on FET has a negative cut-off voltage, and the gate voltage V_{g} is operating in the negative range. And we restrict the video signal voltage V_{d} in the positive range. Therefore, the 4 diodes can be used to block the undesired current as show in the FIG. 6. In this design, when a row is selected the gate voltage will be raised to 0. That means for most of the time we should keep a negative voltage V_{g} on the gate to keep the video signal current I_{d} equal to zero.

### The Common Drain Circuit

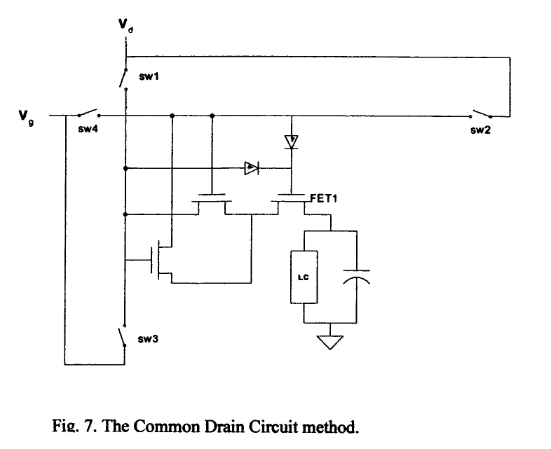

In this circuit, please refer to FIG. 7, we use a normal-off N channel FET₁ as the LC's selection switch. The FET₁'s cut-off voltage is 0, and the gate voltage V_{g} is operating in the positive range. The gate voltage is higher than the video voltage V_{d} when the row is selected; and the gate voltage is set to 0 when the row is not selected. Therefore we can use two pin-pin diodes to control the flow of the FET₁'s gate current I_{g}; and use another two n channel FET to control the direction of the FET₁'s draining current I_{d} as illustrated in FIG. 7.

What we claim as our invention are as follows:

1. A method uses the “row/column buffer switches” that lets LCD to scan either vertically or horizontally. That a rectangle LCD can accept either a landscape or a portrait image without a pre-rotate process.

2. According to claim 1, a method to solve the unequal column and row number issue.
1) Using the Extra Scan Lines Scheme.
2) Using the Extra Column Buffer Scheme.

3. According to claim 1 and 2, a method to solve the TFT LCD electrode direction issue.
1) Using Common Source Circuit.
2) Using Common Drain Circuit.
